(19) United States
(12) Patent Application Publication
(10) Pub. No.: US 2023/0053078 A1
(43) Pub. Date: Feb. 16, 2023

(54) COATING FOR PROTECTING A SUBSTRATE

(71) Applicant: Advanced Innergy LTD, Gloucester (GB)

(72) Inventor: Simon Harry Shepherd, Gloucester (GB)

(21) Appl. No.: 17/791,108

(22) PCT Filed: Jan. 5, 2021
(86) PCT No.: PCT/GB2021/050021

§ 371 Date: Jul. 6, 2022

(30) Foreign Application Priority Data
Jan. 7, 2020 (GB) 2000180.6
Apr. 7, 2020 (GB) 2005145.4

(51) Int. Cl. C09D 171/14; C09D 161/06

(52) U.S. Cl. CPC C09D 171/14; C09D 161/06

(57) ABSTRACT

A mixture curable to provide a fibre reinforced coating material for protecting a substrate. The mixture comprises a phenolic resin or a polyfurfuryl alcohol resin, a hardener, a thixotropic additive, and fibres.

### TECHNOLOGICAL FIELD

Examples of the disclosure relate to mixtures, fibre reinforced coating materials, protected substrates and methods for protecting substrates.

### BACKGROUND

Fibre reinforced coating materials are often applied to substrates, for instance exposed or insulated surfaces of oil or gas rigs. In such examples, fibre reinforced coating materials may provide the substrate with a degree of protection from extreme environmental conditions, abrasion and impact damage.

In some instances, a fibre reinforced coating material may be required on the underside of a substantially horizontal surface, for example on the underdeck of an oil or gas rig, or on an inclined or substantially vertical surface.

There is a desire to provide improved fibre reinforced coating materials and methods of their application, for instance, which are suitable for application on the underside of a substantially horizontal surface or on an inclined or substantially vertical surface.

All proportions referred to in this specification are indicated as % by weight of the total mixture.

### BRIEF SUMMARY

According to various, but not necessarily all, examples of the disclosure there is provided a mixture curable to provide a fibre reinforced coating material for protecting a substrate, wherein the mixture comprises:

a phenolic resin or a polyfurfuryl alcohol resin;

a hardener;

a thixotropic additive; and

fibres.

The phenolic resin may comprise phenol-formaldehyde resin with a free formaldehyde to phenol molar ratio of less than one.

The hardener may comprise an acidic catalyst. The acidic catalyst may comprise phosphoric acid, sulfonic acid, sulfuric acid, or derivatives of any of: phosphoric acid, sulfonic acid or sulfuric acid.

The thixotropic additive may comprise: fumed silica, nano-clays, cellulosic materials, mineral powders, or mixtures thereof. The mineral powders may comprise: hydrate aluminium oxide, quartz, kaolin, or silica aerogel. The thixotropic additive may preferably comprise a cellulosic material, and may most preferably comprise fibrillated cellulose.

The fibres may comprise: carbon fibres, boron fibres, glass fibres, or textile fibres. The fibres may comprise glass fibres.

The mixture may also comprise a silane additive, which may be an aminofunctional silane

Possibly, the mixture is a three-part mixture, wherein

a first part of the three-part mixture comprises: the phenolic resin or the polyfurfuryl alcohol resin, and the thixotropic additive;

a second part of the three-part mixture comprises: the hardener; and

a third part of the three-part mixture comprises the fibres.

The three-part mixture may comprise 30 to 80% by weight of the first part, and preferably may comprise 40 to 70% by weight of the first part, and most preferably may comprise 50 to 65% by weight of the first part.

The three-part mixture may comprise 1 to 15% by weight of the second part, and preferably may comprise 1 to 12% by weight of the second part, and most preferably may comprise 2 to 10% by weight of the second part.

The three-part mixture may comprise 5 to 50% by weight of the third part, and preferably may comprise 15 to 45% by weight of the third part, and most preferably may comprise 25 to 35% by weight of the third part.

The ratio of first part to second part may be from 5:1 to 20:1, and preferably may be from 6:1 to 16:1. The ratio of combined first and second parts to third part may be from 10:1 to 1:1, and preferably may be from 9:1 to 1.5:1. The ratio of first part to third part may be from 10:1 to 1:1, and preferably may be from 8:1 to 1.5:1.

According to various, but not necessarily all, examples of the disclosure there is provided a fibre reinforced coating material for protecting a substrate, the fibre reinforced coating material being the cured product of a mixture comprising: a phenolic resin or a polyfurfuryl alcohol resin, a hardener, a thixotropic additive, and fibres.

According to various, but not necessarily all, examples of the disclosure there is provided a method of protecting a substrate, the method comprising:

applying a mixture to a substrate, wherein the mixture comprises: a phenolic resin or a polyfurfuryl alcohol resin, a hardener, a thixotropic additive, and fibres; and

allowing the mixture to cure to provide a substrate comprising a fibre reinforced coating material for protecting the substrate.

Possibly, the mixture is applied to the substrate by spraying the mixture on to the substrate.

Possibly, the mixture is a three-part mixture, wherein

a first part of the three-part mixture comprises: the phenolic resin or the polyfurfuryl alcohol resin, and the thixotropic additive;

a second part of the three-part mixture comprises: the hardener; and

a third part of the three-part mixture comprises the fibres; and

wherein the method comprises mixing the first part, second part, and third part of the three-part mixture and allowing the three-part mixture to cure to provide a substrate comprising a fibre reinforced coating material for protecting the substrate.

Possibly, the method comprises mixing the first part and the second part, and subsequently mixing the mixed first and second parts with the third part. Possibly, the mixture is applied to the substrate by spraying the mixture on to the substrate, and wherein the method comprises ejecting the mixed first and second parts from a first outlet of an applicator, and ejecting the third part through a second outlet of the applicator such that the mixed first and second parts mix with the third part following ejection from the applicator. The method may comprise mixing the mixed first and second parts with the third part in mid-air following ejection from the respective first and second outlets. The method may comprise orientating the respective first and second outlets such that a flow of ejected mixed first and second parts intercepts a flow of ejected third part in mid-air.

The method may comprise applying the mixture on the underside of a substantially horizontal surface of a substrate or on an inclined or substantially vertical surface of a substrate, and may comprise applying the mixture on the underdeck of an oil or gas rig.

According to various, but not necessarily all, examples of the disclosure there is provided a protected substrate, the protected substrate comprising a fibre reinforced coating material, wherein the fibre reinforced coating material is the cured product of a mixture comprising: a phenolic resin or a polyfurfuryl alcohol resin;

a hardener, a thixotropic additive; and

fibres.

According to various, but not necessarily all, examples of the disclosure there may be provided examples as claimed in the appended claims.

### BRIEF DESCRIPTION

For a better understanding of various examples that are useful for understanding the detailed description, reference will now be made by way of example only.

### DETAILED DESCRIPTION

Examples of the disclosure provide a mixture curable to provide a fibre reinforced coating material for protecting a substrate, for instance, from extreme environmental conditions, abrasion and impact damage.

Substrates include, for example, exposed or insulated surfaces of oil or gas rigs such as the underdeck of an oil or gas rig. The surface of a substrate may be coated, for example, with a tie coat layer and/or an anticorrosion layer. An insulated substrate comprises an insulation material on its outer surface. Accordingly, in such examples fibre reinforced coating materials are applied to the surface of the insulating material. In some examples, a tie coat layer, for example an epoxy tie coat layer, is provided on the surface of the insulating material to improve adhesion to the fibre reinforced coating material.

A mixture according to examples of the disclosure comprises a phenolic resin or a polyfurfuryl alcohol resin, a hardener, a thixotropic additive, and fibres. Examples of mixtures according to the disclosure are provided below.

TABLE 1

| | E1 | E2 | E3 | E4 | E5 | E6 |
|---|---|---|---|---|---|---|
| Component | (wt %) | (wt %) | (wt %) | (wt %) | (wt %) | (wt %) |
| First part | 61 | 70.4 | 79.2 | 61.2 | 60.0 | 58.5 |
| Second part | 9 | 9.6 | 10.8 | 3.8 | 5.0 | 6.5 |
| Third part | 30 | 20.0 | 10.0 | 35.0 | 35.0 | 35.0 |

In the examples of Table 1 above, the mixture is a three-part mixture.

In some examples, the ratio of first part to second part is from 5:1 to 20:1, and preferably from 6:1 to 16:1.

In some examples, the ratio of combined first and second parts to third part is from 10:1 to 1:1, and preferably from 9:1 to 1.5:1.

In some examples, the ratio of first part to third part is from 10:1 to 1:1, and preferably from 8:1 to 1.5:1.

A first part of the three-part mixture comprises the phenolic resin or the polyfurfuryl alcohol resin, and the thixotropic additive. Table 2 below provides details of example first parts.

TABLE 2
Example first parts

| | Specific example | Example 1 | Example 2 | Example 3 |
|---|---|---|---|---|
| Component | of component | (wt %) | (wt %) | (wt %) |
| Phenolic resin | Phenolic resin with a free | 90 | 89.5 | None |
| | formaldehyde to phenol | | | |
| | molar ratio of less than one | | | |
| Polyfurfuryl alcohol resin | Polyfurfuryl alcohol resin | None | None | 94 |
| Thixotropic additive | Fibrillated cellulose | 10 | 9.5 | 6 |
| Silane additive | Aminofunctional silane | None | 1 | None |

As detailed in table 2 above, in some examples comprising a phenolic resin (for instance, examples 1 and 2), the phenolic resin comprises phenol-formaldehyde resin with a free formaldehyde to phenol molar ratio of less than one. The phenolic resin may be a liquid phenolic resin, and may be low viscosity, low free formaldehyde, unmodified liquid phenolic resin. In examples of the disclosure the phenolic resin used is EXP 5E 8013S from Prefere resins. The phenolic resin may have a viscosity at 25° C. of 350 to 450 cP. The phenolic resin may have a pH at 25° C. of 7.0 to 7.5. The phenolic resin may have a solid content (2 g/2 hrs/135° C.) of 69.0 to 74%. The phenolic resin may have a water content of 14 to 16%. The phenolic resin may have free formaldehyde of less than 1.0%. The phenolic resin may have a phenol content of 3.0 to 7.0%. The phenolic resin may have a pot life of 7.0 to 25.0 mins.

In other examples (for instance, example 3), a polyfurfuryl alcohol (PFA) resin is used instead of a phenolic resin. PFA is available under the trade name Furolite® Resin from TransFurans Chemicals. A PFA resin is a polymeric furfuryl alcohol thermoset resin system.

As detailed in table 2 above, in some examples the thixotropic additive comprises fibrillated cellulose, which is a cellulosic material. Alternatively, the thixotropic additive may comprise, for example, fumed silica, nano-clays, other cellulosic materials, mineral powders, or mixtures thereof. In some examples, the thixotropic additive may comprise fibres, for example carbon fibres, boron fibres, glass fibres, or textile fibres.

The mineral powders may comprise: hydrate aluminium oxide, quartz, kaolin, or silica aerogel.

The thixotropic additive is a shear thinning additive, and therefore modifies the rheology of the first part such that the viscosity of the first part decreases under strain.

Optionally, the first part may also comprise a silane additive, for example an aminofunctional silane, such as DOW CORNING® Z-6137 (see example 2 of table 2).

The silane additive induces superior bonding between the fibres in the mixture and the phenolic resin of the first part.

A second part of the three-part mixture comprises the hardener for curing the phenolic resin or polyfurfuryl alcohol resin. The hardener may comprise an acidic catalyst, such as phosphoric acid, sulfonic acid, or sulfuric acid. In some examples, the acidic catalyst may be a derivative of any of phosphoric acid, sulfonic acid or sulfuric acid. The acidic catalyst could be a mixture of any of the abovementioned acids (or derivatives thereof). The hardener is therefore the catalyst. The same hardener may be used irrespective of whether the resin is a phenolic resin or a polyfurfuryl alcohol resin. In some examples, the hardener used is Phencat 10® acid catalyst available from Hexion.

A third part of the three-part mixture comprises the fibres, for example inorganic fibres such as glass fibres. In other examples the fibres may comprise: carbon fibres, boron fibres, or textile fibres. In some examples, the first part may also comprise some of the fibres, for example about 5% of the overall quantity of fibres.

A curable mixture is a mixture which sets or hardens, for example, due to a chemical reaction with the hardener. Accordingly, the fibre reinforced coating material is the set or hardened product that results from the mixture curing, i.e. the cured product. Examples of the disclosure also therefore provide a fibre reinforced coating material, i.e. the cured product of the mixture, which may be a body of fibre reinforced coating material.

### Method

Examples of the disclosure also provide a method of protecting a substrate. The method comprises applying a mixture to a substrate, wherein the mixture comprises: a phenolic resin or a polyfurfuryl alcohol resin, a hardener, a thixotropic additive, and fibres. The method comprises allowing the mixture to cure to provide a substrate comprising a fibre reinforced coating material for protecting the substrate. Accordingly, examples of the disclosure also provide a protected substrate.

In some examples, the thickness of the subsequently cured fibre reinforced coating material is from 1 mm to 3 mm. In some examples, the mixture requires about 24 hours to cure at ambient temperature and conditions to a thickness of from 1 mm to 3 mm. Ambient temperature may be from 5 to 50° C., or may be from 15 to 40° C.

In some examples, the mixture is applied to the substrate by spraying the mixture on to the substrate, i.e. on the outer surface of the substrate. The mixture is therefore a sprayable mixture. Alternatively, the mixture may be applied to the substrate by hand lay-up.

In examples where the mixture is a three-part mixture, the method comprises mixing the first part, second part, and third part of the three-part mixture, and allowing the three-part mixture to cure to provide a substrate comprising a fibre reinforced coating material for protecting the substrate.

The first part (for example table 1) may be provided by mixing the phenolic resin or polyfurfuryl alcohol resin and thixotropic additive under high shear conditions. For example, the phenolic resin or polyfurfuryl alcohol resin and thixotropic additive may be mixed using a Silverson high shear mixer at around 7000 RPM for between 5 and 30 minutes. The thixotropic additive may be added to the phenolic resin or polyfurfuryl alcohol resin.

In some examples, the method comprises mixing the first part and the second part, and subsequently mixing the mixed first and second parts with the third part. In such examples, the mixture may be applied to the substrate by spraying the mixture on to the substrate, i.e. on to an outer surface of the substrate. The method may comprise ejecting the mixed first and second parts from a first outlet of an applicator, and ejecting the third part through a second outlet of the applicator such that the mixed first and second parts mix with the third part following ejection from the applicator. Accordingly, the first and second parts may be mixed in a first chamber fluidly connected to the first outlet, and the third part may be provided in a second chamber fluidly connected to the second outlet. The first chamber may comprise a static mixer of the applicator. The second chamber may comprise a chopper gun.

In such examples, the mixed first and second parts mix with the third part to an extent in mid-air following ejection from the respective first and second outlets, for example, because the respective first and second outlets have been orientated such that a flow of ejected mixed first and second parts intercepts a flow of ejected third part in mid-air. Accordingly, in such examples the mixed phenolic resin or polyfurfuryl alcohol resin-hardener system (mixed first and second parts) is ejected from the applicator alongside a stream of chopped fibres (third part). The phenolic resin or polyfurfuryl alcohol resin-hardener system and chopped fibres mix in the air and are deposited on a surface of a substrate to be protected.

The applicator may be an airless spray-gun. Any surface of the applicator which may contact the mixed first and second parts may have an acid resistant coating or surface.

There is thus described mixtures, fibre reinforced coating materials, protected substrates and methods for protecting substrates with a number of advantages. For instance, as mixtures according to examples of the disclosure comprise a thixotropic additive, the viscosity of such mixtures is dependent on the stress being applied to the mixture. Accordingly, under conditions of low stress, i.e. a static condition, the mixture has a relatively high viscosity, whereas under conditions of high stress, such as when the mixture is agitated or shaken or has been ejected out of an applicator, the mixture has a relatively low viscosity.

Accordingly, mixtures can be agitated, for instance, by rapid mixing and/or shaking and/or ejection from an applicator, to decrease viscosity. Mixtures in this state can readily be applied to a substrate, for instance, by spraying.

Once applied to a substrate, the mixture becomes static, and thus its viscosity increases. The increase in viscosity causes the mixture to substantially set, i.e. to resist further flow. It has been found in examples of the disclosure that the mixture can be applied on the underside of a substantially horizontal surface, for example on the underdeck of an oil or gas rig, or on an inclined or substantially vertical surface, and will substantially set without running down the surface, sagging, slumping or delaminating from the surface of the substrate. Furthermore, the mixture can readily be applied to complex substrates, for example by spray application.

Accordingly, example mixtures are shear thinning, i.e. the viscosity decreases under shear strain.

In examples comprising a three-part mixture, the viscosity of the mixture can be further reduced by mixing the first part and the second part, and subsequently mixing the mixed first and second parts with the third part, for instance in mid-air after ejection from a spray applicator.

Examples of the disclosure significantly reduce the time taken to protect a particular substrate (and hence costs), for instance the underdeck of an oil or gas rig, compared to labour intensive conventional systems which require hand lay-up of sections of laminated glass cloth with a curable two-part resin system or the application of riveted stainless steel.

Furthermore, fibre reinforced coating materials according to examples of the disclosure protect a substrate, for instance, from extreme environmental conditions, abrasion and impact damage. For instance, in examples where the substrate is insulated, the fibre reinforced coating material provides impact and water proofing protection to the underlying insulation material layer.

Furthermore, fibre reinforced coating materials according to examples of the disclosure are flame retardant.

Furthermore, fibre reinforced coating materials according to examples of the disclosure provide protection in the event of a cryogenic-spill, i.e. on the deck of a ship.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

The term “comprise” is used in this document with an inclusive not an exclusive meaning. That is any reference to X comprising Y indicates that X may comprise only one Y or may comprise more than one Y. If it is intended to use “comprise” with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term “example” or “for example” or “may” in the text denotes, whether explicitly stated or not, that such features or functions are present in at least the described example, whether described as an example or not, and that they can be, but are not necessarily, present in some of or all other examples. Thus “example”, “for example” or “may” refers to a particular instance in a class of examples. A property of the instance can be a property of only that instance or a property of the class or a property of a sub-class of the class that includes some but not all of the instances in the class. It is therefore implicitly disclosed that features described with reference to one example but not with reference to another example, can where possible be used in that other example but does not necessarily have to be used in that other example.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A mixture curable to provide a fibre reinforced coating material for protecting a substrate, wherein the mixture comprises:
a phenolic resin or a polyfurfuryl alcohol resin;
a hardener;
a thixotropic additive; and
fibres.

2. A mixture according to claim 1, wherein the phenolic resin comprises phenol-formaldehyde resin with a free formaldehyde to phenol molar ratio of less than one.

3. A mixture according to claim 1, wherein the hardener comprises an acidic catalyst.

4. (canceled)

5. A mixture according to claim 1, wherein the thixotropic additive comprises: fumed silica, nano-clays, cellulosic materials, or mineral powders.

6. A mixture according to claim 1, wherein the thixotropic additive comprises cellulosic materials.

7. A mixture according to claim 6, wherein the cellulosic materials comprise fibrillated cellulose.

8. (canceled)

9. A mixture according to claim 1, wherein the mixture comprises a silane additive.

10. A mixture according to claim 1, wherein the mixture is a three-part mixture, wherein
a first part of the three-part mixture comprises the phenolic resin or the polyfurfuryl alcohol resin and the thixotropic additive;
a second part of the three-part mixture comprises the hardener; and
a third part of the three-part mixture comprises the fibres.

11. A mixture according to claim 10, wherein the three-part mixture comprises 30 to 80% by weight of the first part.

12-13. (canceled)

14. A mixture according to claim 10, wherein the three-part mixture comprises 1 to 15% by weight of the second part.

15-16. (canceled)

17. A mixture according to claim 10, wherein the three-part mixture comprises 5 to 50% by weight of the third part.

18-19. (canceled)

20. A method of protecting a substrate, the method comprising:
applying a mixture to a substrate, wherein the mixture comprises: a phenolic resin or a polyfurfuryl alcohol resin, a hardener, a thixotropic additive, and fibres; and
allowing the mixture to cure to provide a substrate comprising a fibre reinforced coating material for protecting the substrate.

21. A method according to claim 20, wherein the mixture is a three-part mixture, wherein
a first part of the three-part mixture comprises: the phenolic resin or the polyfurfuryl alcohol resin and the thixotropic additive;
a second part of the three-part mixture comprises the hardener; and
a third part of the three-part mixture comprises the fibres; and
wherein the method comprises mixing the first part, second part, and third part of the three-part mixture and allowing the three-part mixture to cure to provide a substrate comprising a fibre reinforced coating material for protecting the substrate.

22. A method according to claim 21, wherein the method comprises mixing the first part and the second part, and subsequently mixing the mixed first and second parts with the third part.

23. A method according to claim 22, wherein the mixture is applied to the substrate by spraying the mixture on to the substrate, and wherein the method comprises:
ejecting the mixed first and second parts from a first outlet of an applicator; and
ejecting the third part through a second outlet of the applicator such that the mixed first and second parts mix with the third part following ejection from the applicator.

24. A method according to claim 23, wherein the method comprises:
mixing the mixed first and second parts with the third part in mid-air following ejection from the respective first and second outlets.

25. A method according to claim 24, wherein the method comprises:
orientating the respective first and second outlets such that a flow of ejected mixed first and second parts intercepts a flow of ejected third part in mid-air.

26. A method according to claim 20, wherein the method comprises:
applying the mixture on the underside of a substantially horizontal surface of a substrate or on an inclined or substantially vertical surface of a substrate.

27. A method according to claim 26, wherein the method comprises:
applying the mixture on the underdeck of an oil or gas rig.

28. A fibre reinforced coating material for protecting a substrate, the fibre reinforced coating material being the cured product of a mixture comprising: a phenolic resin or a polyfurfuryl alcohol resin, a hardener, a thixotropic additive, and fibres.

29. (canceled)
